(19) United States
(12) Patent Application Publication
(10) Pub. No.: US 2014/0346375 A1
(43) Pub. Date: Nov. 27, 2014

(54) LASER APPARATUS, LASER SYSTEM, AND EXTREME ULTRAVIOLET LIGHT GENERATION APPARATUS

(71) Applicant: GIGAPHOTON INC., Tochigi-ken (JP)

(72) Inventors: Krzysztof NOWAK, Tochigi-ken (JP); Takashi SUGANUMA, Tochigi-ken (JP); Osamu WAKABAYASHI, Tochigi-ken (JP)

(21) Appl. No.: 14/455,669

(22) Filed: Aug. 8, 2014

Related U.S. Application Data
(63) Continuation of application No. PCT/IB2013/000356, filed on Mar. 8, 2013.
(60) Provisional application No. 61/617,446, filed on Mar. 29, 2012.

(30) Foreign Application Priority Data
Jan. 9, 2013 (JP) 2013-001704

(51) Int. Cl. H01S 3/10; H01S 3/104; H01S 3/097; H05G 2/00

(52) U.S. Cl. CPC H01S 3/10015; H05G 2/008; H01S 3/104; H01S 3/097
USPC 250/504 R; 359/342

(57) ABSTRACT

A laser apparatus includes a master oscillator configured to output a pulse laser beam, at least one amplifier disposed in an optical path of the pulse laser beam, an energy detector that is disposed in the optical path on one of an input side and an output side of the amplifier and that is configured to detect energy of self-oscillating light from the amplifier, a gain adjustment section configured to adjust the gain of the amplifier, and a control unit configured to control the gain adjustment section based on a detection result from the energy detector when a pulse laser beam is not being inputted into the amplifier from the master oscillator.

### CROSS-REFERENCE TO RELATED APPLICATIONS

The present application claims the benefit of U.S. Provisional Patent Application Ser. No. 61/617,446 filed Mar. 29, 2012, and Japanese Patent Application No. 2013-001704 filed Jan. 9, 2013.

### BACKGROUND

1. Technical Field

The present disclosure relates to apparatuses that supply a target irradiated by a laser beam for the purpose of generating extreme ultraviolet (EUV) light. The present disclosure also relates to apparatuses for generating extreme ultraviolet (EUV) light using such target supply apparatuses.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A laser apparatus may include a master oscillator, at least one amplifier, an energy detector, a gain adjustment section, and a control unit. The master oscillator may be configured to output a pulse laser beam. The at least one amplifier may be disposed in an optical path of the pulse laser beam. The energy detector may be disposed in the optical path on one of an input side and an output side of the amplifier and may be configured to detect energy of self-oscillating light from the amplifier. The gain adjustment section may be configured to adjust the gain of the amplifier. The control unit may be configured to control the gain adjustment section based on a detection result from the energy detector when a pulse laser beam is not being inputted into the amplifier from the master oscillator.

### BRIEF DESCRIPTION OF THE DRAWINGS

Hereinafter, selected embodiments of the present disclosure will be described with reference to the accompanying drawings.

FIG. 1 illustrates the overall configuration of an exemplary LPP type EUV light generation apparatus.

FIG. 2 illustrates an overview of a laser apparatus according to an embodiment.

FIG. 3 illustrates a control flowchart of a laser controller.

FIG. 4 illustrates a control flowchart of a control unit.

FIG. 5A illustrates an overview of an amplifying chamber in an amplifier according to an embodiment.

FIG. 5B illustrates an overview of an amplifying unit including monitor according to an embodiment.

FIG. 6 illustrates an overview of an amplifier that includes a gas adjustment section according to an embodiment.

FIG. 7 is a diagram illustrating a control flowchart of a control unit.

FIG. 8 illustrates a relationship between Xe concentration and self-oscillating light energy.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### Contents

### 1. Overview

### 2. Terms

### 3. Overview of Extreme Ultraviolet Light Generation Apparatus

### 3.1 Configuration

### 3.2 Operation

### 4. Laser Apparatus Including Amplifier

### 4.1 Configuration

### 4.2 Operation

### 4.3 Effect

### 5. Amplifier Including Monitor

### 5.1 Configuration

### 5.2 Operation

### 5.3 Effect

### 5.4 Other

### 6. Amplifier Including Gas Adjustment Section

### 6.1 Configuration

### 6.2 Operation

### 6.3 Effect

### 6.4 Other

### 1. Overview

A driver laser apparatus for an LPP EUV light generation apparatus is required to output a pulse laser beam having a high pulse energy at a high repetition rate. A high-power CO₂ laser apparatus is used as a driver laser for an LPP EUV light generation apparatus.

A MOPA-type high-power CO₂ laser apparatus may include a master oscillator MO that outputs a short-pulse laser beam at a high repetition rate and a plurality of amplifiers PA that amplify the pulse laser beam, in order to obtain a pulse laser beam at high power. Note that even in the case where a pulse laser beam from the master oscillator MO does not enter, the amplifiers PA may self-oscillate if a laser gas is being pumped. It is often difficult to control the repetition rate of self-oscillating light produced by the self-oscillation.

### 2. Terms

Several terms used in the present application will be described hereinafter. A “chamber” is a receptacle, in an LPP type EUV light generation apparatus, that is used to isolate a space in which plasma is generated from the exterior. A “target supply device” is a device for supplying a target material that is used for generating EUV light, such as melted tin, to the interior of a chamber. An “EUV collector mirror” is a mirror for reflecting EUV light radiated from plasma and outputting that light to the exterior of a chamber. “Gain” refers to a gain at which a laser beam is amplified. Self-oscillation may occur in the case where the gain of an amplifier is extremely high. The gain can be increased/reduced by altering the pumping intensity of a laser medium, altering the composition of a laser medium, and so on.

### 3. Overview of EUV Light Generation System

### 3.1 Configuration

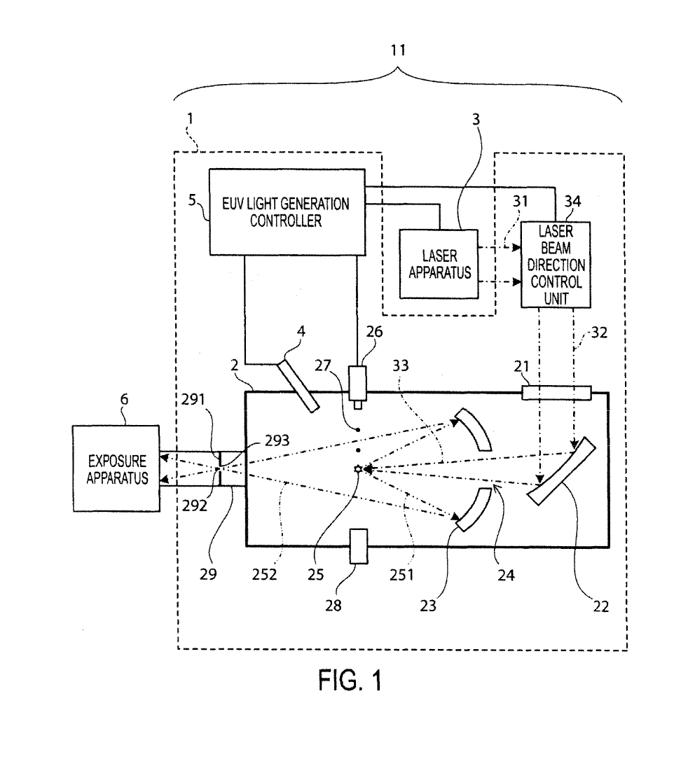

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture 293 may be provided in the connection part 29. The wall 291 may be positioned such that the second focus of the EUV collector mirror 23 lies in the aperture 293 formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 3.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 33 travels, and the position at which the pulse laser beam 33 is focused. It will be appreciated that the various controls mentioned above are merely examples, and other controls may be added as necessary.

### 4. Laser Apparatus Including Amplifier System

### 4.1 Configuration

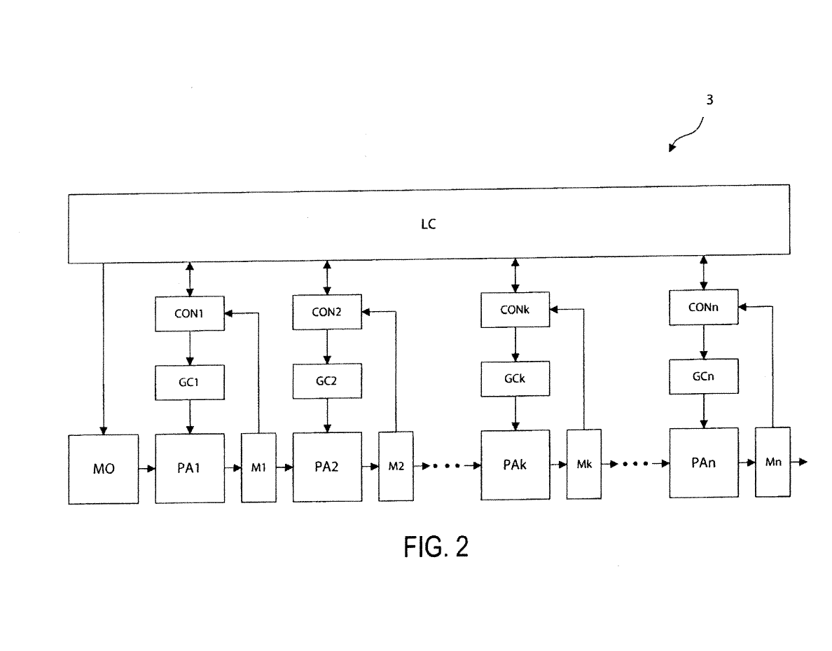

FIG. 2 illustrates an overview of the laser apparatus 3 according to an embodiment.

As shown in FIG. 2, the laser apparatus 3 may include a laser controller LC, the master oscillator MO, at least one amplifier PA, at least one monitor M, at least one control unit CON, and at least one gain adjustment section GC. For example, the laser apparatus 3 may include n amplifiers PA1 to PAn, as well as corresponding monitors M1 to Mn, control units CON1 to CONn, and gain adjustment sections GC1 to GCn.

The at least one amplifier PA may be disposed in the optical path of a pulse laser beam outputted from the master oscillator MO. The amplifiers PA1 to PAn may employ CO₂ laser gas as a medium.

The at least one monitor M may be disposed in the optical path of the pulse laser beam outputted from the master oscillator MO, on the output side of the amplifier PA. The monitors M0 to Mn may configure energy detectors that detect the energy of self-oscillating light outputted from the amplifiers PA1 to PAn.

The laser controller LC may be connected to the master oscillator MO and the control units CON1 to CONn via signal lines.

Output signals from the monitors M1 to Mn may be inputted into the control units CON1 to CONn, respectively. Output signals from the control units CON1 to CONn may be inputted into the gain adjustment sections GC1 to GCn, respectively. Output signals from the gain adjustment sections GC1 to GCn may be inputted into the amplifiers PA1 to PAn, respectively. The amplifying gain of the amplifiers PA1 to PAn may be controlled by adjusting discharges in the amplifiers PA1 to PAn based on the output signals from the gain adjustment sections GC1 to GCn.

### 4.2 Operation

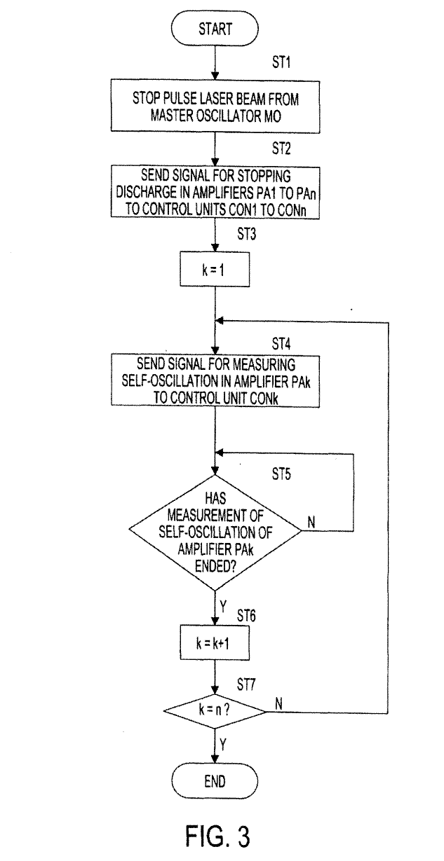

FIG. 3 is a diagram illustrating a flowchart of control performed by the laser controller LC for suppressing self-oscillation. Substantially, FIG. 3 may illustrate operations through which the laser controller LC causes all of the control units CON to measure self-oscillating light energy. However, in this process, each control unit CON may specify control parameter values for each amplifier PA so that self-oscillation falls within a suppressible range. In the case where a seed laser beam outputted from the master oscillator MO is amplified and outputted by an amplifier PAk for EUV light generation, parameter values within a range specified through the operations illustrated in FIG. 3 may be used in the control.

First, in step 1, the laser controller LC may be configured to send a signal for stopping the output of a pulse laser beam to the master oscillator MO (ST1).

Next, in step 2, the laser controller LC may be configured to send, to the control units CON1 to CONn, a signal that sets the amplifying gain of all the amplifiers PA1 to PAn to 0 (ST2). As a result, the gain adjustment sections GC1 to GCn may stop the discharges in all the amplifiers PA1 to PAn.

Next, in step 3, an argument k may be set to k=1 (ST3).

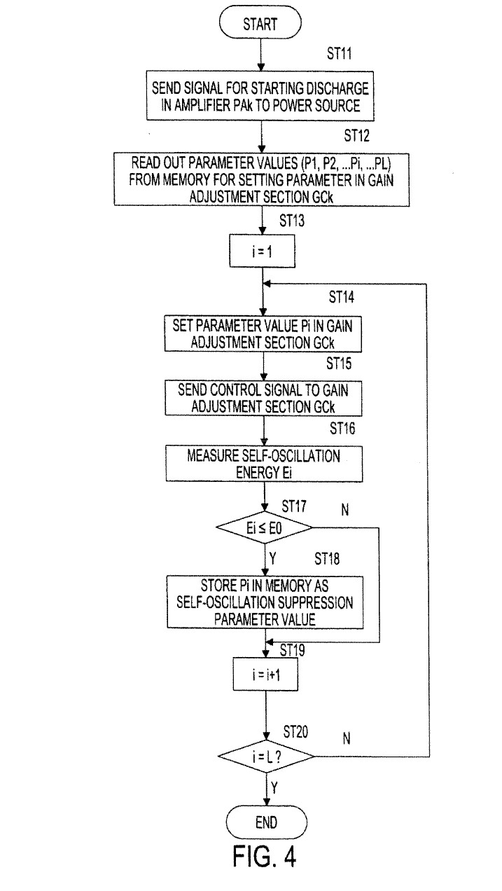

Next, in step 4, the laser controller LC may be configured to send, to a control unit CONk, a signal for measuring self-oscillating light energy (ST4). For example, in the case where k=1, the laser controller LC may be configured to send the signal to the control unit CON1. Having received the signal, the control unit CONk may execute the operations illustrated in FIG. 4 and specify a parameter value range in which self-oscillation can be suppressed.

Next, in step 5, the laser controller LC may be configured to determine whether or not the measurement of the self-oscillating light energy in the amplifier PAk has ended (ST5). Step 5 may be repeated until the measurement ends. Whether or not the measurement of the self-oscillating light energy has ended may be determined based on, for example, whether or not the control unit CONk has received a self-oscillating light energy value for all of the parameter values that will be mentioned later.

In the case where the laser controller LC has determined in step 5 that the measurement of the self-oscillating light energy in the kth amplifier PAk has ended, in step 6, k may be set to k+1 (ST6).

Next, in step 7, the laser controller LC may be configured to determine whether or not k=n (ST7). In the case where k≠1 in step 7, the procedure may return to step 4. However, in the case where k=n in step 7, the laser controller LC may end the control.

FIG. 4 is a diagram illustrating a control flowchart of the control unit CON.

Control performed by the control unit CONk may be executed in step 4 of the control performed by the laser controller LC illustrated in FIG. 3.

First, in step 11, the control unit CONk may be configured to send, to a power source (not shown) of the kth amplifier PAk, a signal for causing the amplifier PAk to start a discharge, via a gain adjustment section GCk (ST11).

Next, in step 12, the control unit CON1 may be configured to read out, for example, L types of parameter values (P1, P2, . . . Pi, . . . PL) from a memory or the like (not shown) in order to set parameters in the gain adjustment section GCk (ST12). The parameter values may be voltages or duty ratios.

Next, in step 13, the control unit CONk may be configured to set an argument i to i=1 (ST13).

Next, in step 14, the control unit CONk may be configured to set a parameter value Pi in the gain adjustment section GCk (ST14).

Next, in step 15, the control unit CONk may be configured to send a control signal including the parameter value Pi set in the gain adjustment section GCk (ST15). Consequently, the kth amplifier PAk may operate in accordance with the set parameter value Pi. At this time, a monitor Mk may measure a self-oscillating light energy Ei value.

Next, in step 16, the control unit CONk may be configured to receive a signal including the self-oscillating light energy Ei value measured by the monitor Mk (ST16).

Next, in step 17, the control unit CONk may be configured to determine whether or not Ei≦E0 (ST17). Here, E0 may represent the permissible self-oscillation energy, and may be determined based on a damage threshold of optical components disposed in a laser beam path or the like. E0 may preferably be 0.

In the case where E1 is not less than or equal to E0 in step 17, the procedure may proceed to step S19.

However, in the case where E1≦E0 in step S17, in step S18, the parameter value Pi may be stored in a memory as a self-oscillation suppression parameter value (ST18).

Next, in step 19, the argument i may be set to i+1 (ST19).

Next, in step 20, it may be determined whether or not i=L (ST20).

In the case where in step 20, the procedure may return to step 14.

In the case where i=L in step 20, the control unit CONk may be configured to stop the discharge in the amplifier PAk.

In the above operations, first, the laser controller LC may be configured to send a signal for stopping the output of a pulse laser beam to the master oscillator MO. Next, the laser controller LC may be configured to send, via the control unit CONk, a signal for setting the gain of all the amplifiers PAk to 0, and may be configured to stop the discharges therein. Thereafter, the laser controller LC may send a signal for measuring the self-oscillating light energy to each control unit CONk.

The control unit CON1 may be configured to send, via the gain adjustment section GC1, a signal that sequentially changes a corresponding parameter value in order to change the gain of the amplifier PA1. The control unit CON1 may be configured to find a parameter value range that suppresses self-oscillation, based on a signal indicating the self-oscillating light energy value obtained each time via the monitor M1 and the parameter value set at that time. The control unit CON1 may then be configured to store the parameter value range that suppresses self-oscillation. Thereafter, the control unit CON1 may be configured to send a signal to the amplifier PA1 to set the gain to 0, and may be configured to stop the discharge therein.

The control units CON2 to CONn may be configured to sequentially execute the same processing as the control unit CON1, and may find and store the parameter value ranges that suppress self-oscillation for the corresponding amplifiers PA2 to PAn.

When the pulse laser beam outputted from the master oscillator MO is amplified and outputted by the amplifier PAk, the control unit CONk may be capable of controlling the amplifier PAk within the pre-stored parameter value range that is capable of suppressing self-oscillation in the corresponding amplifier PAk.

### 4.3 Effect

Because a parameter value range capable of suppressing self-oscillation in the amplifier PAk is measured in advance and the amplifier PAk is controlled within the parameter value range, it may be possible to suppress self-oscillation in the amplifier PAk.

### 5. Amplifier Including Monitor

### 5.1 Configuration

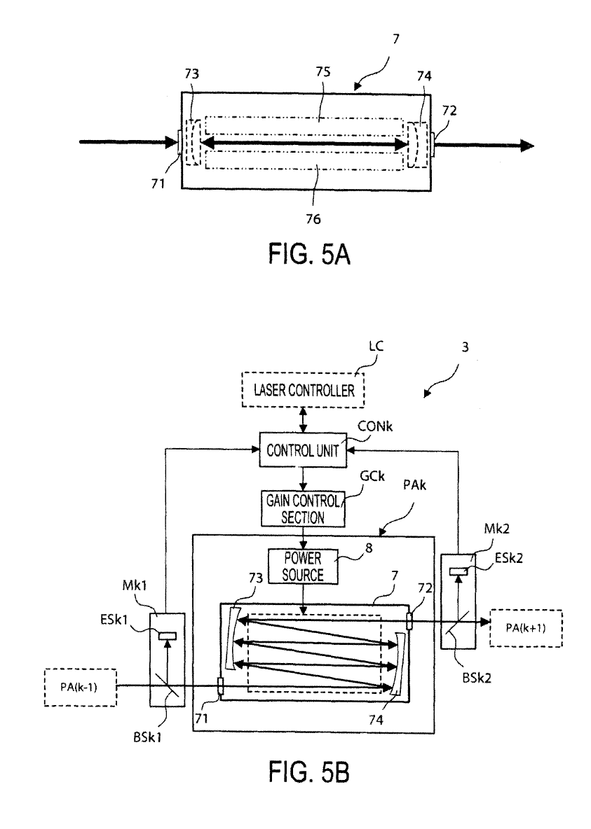

FIG. 5A illustrates an overview of an amplifying chamber 7 in the amplifier PA according to an embodiment. FIG. 5B illustrates an overview of an amplifying unit including the monitor M according to an embodiment.

The amplifying unit may include the amplifier PAk, the gain adjustment section GCk, a first monitor Mk1, a second monitor Mk2, and the control unit CONk.

The amplifier PAk may be a slab amplifier, and may include the amplifying chamber 7 and a power source 8.

The amplifying chamber 7 may include, for example, an entry window 71, an exit window 72, a first concave mirror 73, a second concave mirror 74, a first electrode 75, and a second electrode 76.

The entry window 71 and the exit window 72 may be disposed within the optical path of the laser beam. The entry window 71 and the exit window 72 may seal the amplifying chamber 7.

The first electrode 75 and the second electrode 76 may be disposed within the amplifying chamber 7, facing each other with a predetermined space provided therebetween. The first electrode 75 and second electrode 76 may be disposed on either side of the optical path of the laser beam.

The first concave mirror 73 and the second concave mirror 74 may be disposed so that a laser beam entering the amplifying chamber 7 via the entry window 71 forms multipass along a predetermined optical path between the first electrode 75 and the second electrode 76.

The amplifying chamber 7 may have CO₂ laser gas injected thereinto.

The power source 8 may be connected to the first electrode 75 and the second electrode 76.

The gain adjustment section GCk may be connected to the power source 8 and the control unit CONk via signal lines.

The first monitor Mk1 may be disposed within the optical path of the laser beam that enters into the amplifying chamber 7. The second monitor Mk2 may be disposed within the optical path of the laser beam that exits from the amplifying chamber 7.

The first monitor Mk1 may include, for example, a first beam splitter BSk1 and a first energy detector ESk1. Likewise, the second monitor Mk2 may include a second beam splitter BSk2 and a second energy detector ESk2.

The first beam splitter BSk1 may be disposed within the optical path of the laser beam that enters into the amplifying chamber 7. The first beam splitter BSk1 may be disposed so as to reflect some of the beam outputted from the amplifier PAk and conduct that beam to the first energy detector ESk1. Likewise, the second beam splitter BSk2 may be disposed in the optical path of the laser beam that exits from the amplifying chamber 7, and may reflect some of the beam outputted from the amplifier PAk and conduct that beam to the second energy detector ESk2.

The control unit CONk may be connected to the gain adjustment section GCk, the first monitor Mk1, and the second monitor Mk2 via signal lines.

### 5.2 Operation

Operations performed in the case where a pumping intensity D serving as an example of a parameter value that controls the gain of the amplifier PAk is used in the control unit CONk illustrated in FIG. 5B will be described according to the flowcharts illustrated in FIG. 3 and FIG. 4.

The laser controller LC may be configured to send a signal that stops the output of a pulse laser beam from the master oscillator MO illustrated in FIG. 2 so that a seed laser beam does not enter the amplifier PAk. In addition, the laser controller LC may send a signal for stopping discharges in the amplifier PAk.

The control unit CONk may be configured to send, via the gain adjustment section GCk, a signal that, by controlling the power source 8, adjusts a potential difference applied between the first electrode 75 and the second electrode 76 so that a pumping intensity value D of the discharges changes within a predetermined range (D1, D2, . . . Di, . . . DL).

The control unit CONk may then be configured to find self-oscillating light energies (E1, E2, . . . Ei, . . . EL) corresponding to the pumping intensity values (D1, D2, . . . Di, . . . DL), using the first monitor Mk1 and the second monitor Mk2. An energy value E of each self-oscillating light may be the sum of the values obtained by the first monitor Mk1 and the second monitor Mk2.

The control unit CONk may be configured to store a range for the pumping intensity value D in which the self-oscillating light energy is no greater than the permissible value E0. The control unit CONk may be configured to control the amplifier PAk within the stored range for the pumping intensity value D when the seed laser beam outputted from the master oscillator MO illustrated in FIG. 2 is to be amplified and outputted by the amplifier PAk.

### 5.3 Effect

Because the pumping intensity value D that can suppress self-oscillation in the amplifier PAk is measured in advance and the amplifier PAk is controlled within the range of the pumping intensity value D, the self-oscillation can be suppressed.

### 5.4 Other

In the present disclosure, the first monitor Mk1 and the second monitor Mk2 are disposed in the optical paths on the input and output sides of the amplifier PAk, respectively, in order to measure the self-oscillating light energy; however, the monitors may be disposed only on one of the input side and the output side.

The potential difference applied between the first electrode 75 and the second electrode 76, or a high-frequency PWM (Pulse Width Modulation) duty ratio, or a PWM cycle, may be controlled as the parameters for changing the pumping intensity value D.

In addition, instead of a slab amplifier containing CO₂ laser gas, a fast axial flow amplifier or a three-axis orthogonal amplifier may be used.

### 6. Amplifier System Including Gas Adjustment Section

### 6.1 Configuration

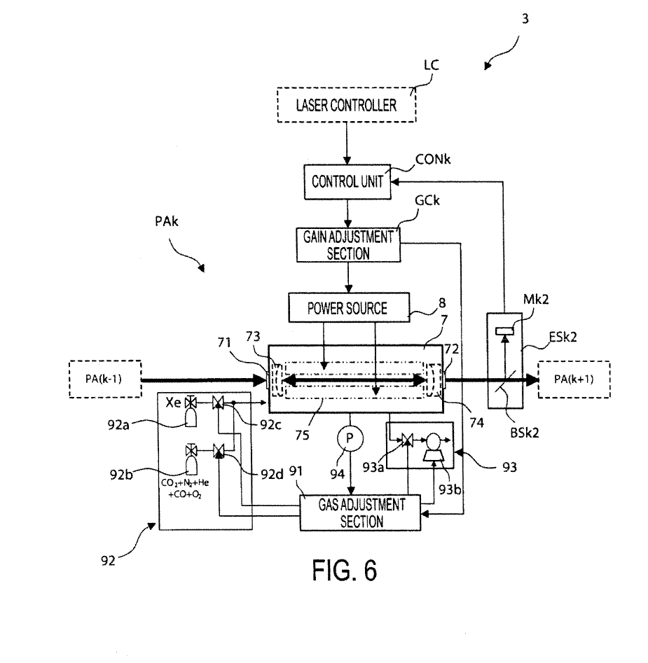

FIG. 6 illustrates an overview of the amplifier PA that includes a gas adjustment section 91 according to an embodiment.

The amplifier PAk that includes the gas adjustment section 91 may be configured so that, for example, the gas adjustment section 91, a Xe gas supply unit 92, and a gas exhaust unit 93 are added to the slab amplifier illustrated in FIG. 5.

The Xe gas supply unit 92 may include, for example, a Xe gas tank 92a, a laser gas tank 92b, a first valve 92c, and a second valve 92d.

A pipe from the Xe gas tank 92a containing Xe gas may be connected to the amplifying chamber 7 via the first valve 92c. A pipe from the laser gas tank 92b containing a laser gas may be connected to the amplifying chamber 7 via the second valve 92d.

The Xe gas tank 92a that contains the Xe gas may contain 100% Xe gas, or may also contain the laser gas. The laser gas may be contained in the laser gas tank 92b that does not contain Xe gas. For example, the gas may contain a mixture of CO₂ gas, N₂ gas, He gas, CO gas, and O₂ gas at predetermined concentrations.

The gas exhaust unit 93 may include an exhaust valve 93a and an exhaust pump 93b. The exhaust valve 93a may be connected to a pipe between the amplifying chamber 7 and a vacuum pump 94.

The gas adjustment section 91 may be connected to signal lines for opening/closing the first valve 92c, the second valve 92d, and the exhaust valve 93a, and may be connected to a signal line for operating the exhaust pump 93b. The gas adjustment section 91 may be inputted with a signal from a pressure sensor (not shown) that measures a pressure in the amplifying chamber 7 and an output signal from the gain adjustment section GCk.

### 6.2 Operations

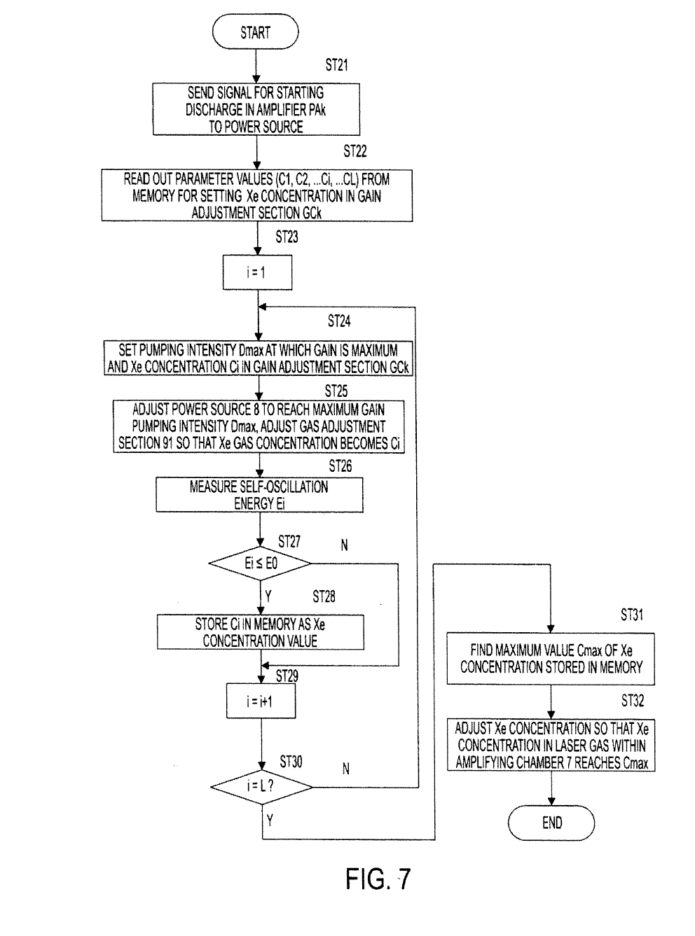

FIG. 7 is a diagram illustrating a control flowchart of the control unit CON.

First, in step 21, the control unit CONk may be configured to send, to the power source 8, a signal for causing the amplifier PAk to start a discharge, via the gain adjustment section GCk (ST21).

Next, in step 22, the control unit CON1 may be configured to read out parameter values (C1, C2, . . . Ci, . . . CL) for setting a Xe concentration in the gain adjustment section GCk from a memory (not shown) (ST22).

Next, in step 23, the control unit CON1 may be configured to set an argument i to i=1 (ST23).

Next, in step 24, the control unit CON1 may be configured to set a pumping intensity value Dmax that produces a maximum gain, and a Xe gas concentration parameter value Ci, in the gain adjustment section GCk (ST24).

Next, in step 25, the gain adjustment section GCk may be configured to send a signal that adjusts the power source 8 so as to take on the maximum gain pumping intensity value Dmax and a signal that adjusts the gas adjustment section 91 so that the Xe gas concentration parameter value becomes Ci (ST25). Consequently, the kth amplifier PAk may operate at the maximum gain pumping intensity value and at the set Xe gas concentration. At this time, the monitor Mk may measure the self-oscillating light energy Ei value.

Next, in step 26, the control unit CON1 may be configured to receive the self-oscillating light energy Ei value measured by the monitor Mk (ST26).

Next, in step 27, the control unit CON1 may be configured to determine whether or not Ei≦E0 (ST27).

In the case where Ei is not less than or equal to E0 in step 27, the procedure may proceed to step S29.

However, in the case where E1≦E0 in step 27, in step 28, the Xe gas concentration parameter value Ci may be stored in a memory as a Xe gas concentration value capable of suppressing self-oscillation (ST28).

Next, in step 29, the control unit CON1 may be configured to set the argument i to i+1 (ST29).

Next, in step 30, the control unit CON1 may be configured to determine whether or not i=L (ST30).

In the case where i≠L in step 30, the procedure may return to step 24.

In the case where i=L in step 30, in step 31, a maximum value Cmax of the Xe concentration values stored in the memory may be found (ST31).

Next, in step 32, the Xe concentration may be adjusted so that the Xe concentration in the laser gas within the amplifying chamber 7 reaches Cmax (ST32). The control may end thereafter.

In the above operations, first, the laser controller LC may be configured to send a signal for stopping the output of a pulse laser beam to the master oscillator MO. Next, the laser controller LC may be configured to send, via the control unit CONk, a signal for setting the gain of all the amplifiers PAk to 0, and may stop the discharges therein. Thereafter, the laser controller LC may be configured to send a signal for measuring the self-oscillating light energy to each control unit CONk.

The control unit CON1 may be configured to control the power source 8 via the gain adjustment section GC1 to set the pumping intensity Dmax at which the gain is maximum, and alter the Xe concentration C in the laser gas within the predetermined Xe concentration range (C1, C2, . . . Ci, . . . CL).

The control unit CON1 may be configured to use a monitor to detect the self-oscillating light energy (E1, E2, . . . Ei, . . . EL) in accordance with the value of the Xe concentration C. The control unit CON1 may be configured to store the value of the maximum Xe concentration Cmax that is less than or equal to the permissible value E0 for the self-oscillating light energy.

When the seed laser beam outputted from the master oscillator MO is amplified and outputted by the amplifier PAk, the control unit CONk may be configured to adjust the Xe gas concentration within the amplifying chamber 7 so as to reach the stored Xe concentration Cmax that is capable of suppressing self-oscillation in the amplifier PAk.

Next, operations performed by the gas adjustment section 91 for adjusting the Xe gas concentration will be described.

The gas adjustment section 91 may be configured to send signals to each of the first valve 92c, the second valve 92d, the exhaust pump 93b, and the exhaust valve 93a so that the exhaust valve 93a opens after first operating the exhaust pump 93b in a state in which the first valve 92c and the second valve 92d are closed. Through this, the amplifier PAk may be exhausted. Then, in the case where a value detected by a pressure sensor (not shown) reaches a predetermined low pressure, the gas adjustment section 91 may send a signal for closing the exhaust valve 93a.

Then, the gas adjustment section 91 may be configured to open the second valve 92d, supply the laser gas, and send a signal for closing the second valve 92d when a total pressure Tp has been reached. If a discharge is produced in this state, the energy of self-oscillating light when the Xe concentration is 0 can be measured.

Next, the exhaust valve 93a may be opened, and the gas adjustment section 91 may be configured to send a signal for closing the exhaust valve 93a when a predetermined pressure Txe has been reached. Then, the gas adjustment section 91 may open the first valve 92c, supply the gas containing Xe, and send a signal for closing the first valve 92c when the total pressure Tp has been reached.

If a discharge is produced in this state, the energy of self-oscillating light at a predetermined Xe concentration can be measured.

The gas adjustment section 91 may be configured to repeat the aforementioned operations for differing values of T×e. Through this, the Xe concentration can be altered to C1, C2, . . . Ci, . . . CL and the self-oscillating light energies corresponding thereto can be measured.

In the case where the self-oscillating light energy is to be measured at a different Xe concentration thereafter, the amplifier PAk may be exhausted to the predetermined low pressure and the aforementioned process may then be performed, or the amplifier PAk may be partially exhausted and the aforementioned process may then be performed.

### 6.3 Effect

Because the Xe concentration Cmax for the gain adjustment section GCk that can suppress self-oscillation in the amplifier PAk is measured in advance and the amplifier PAk is operated at that Xe concentration Cmax, it is possible to suppress self-oscillation.

### 6.4 Other

Although the present disclosure describes an example in which the concentration of Xe gas within the amplifier PAk is adjusted, at least one of a CO₂ gas concentration, an N₂ gas concentration, and a total pressure within the amplifying chamber 7 may be adjusted.

In addition, instead of a slab amplifier containing CO₂ laser gas, a fast axial flow amplifier or a three-axis orthogonal amplifier may be used.

In addition, the laser gas need not contain Xe gas. For example, the gain of the amplifier PAk may be adjusted by adjusting at least one of CO₂ gas, N₂ gas, and the total pressure within the amplifying chamber 7.

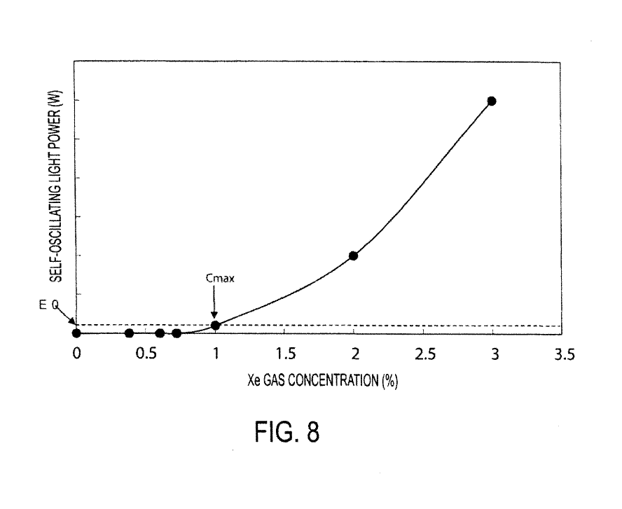

FIG. 8 illustrates a relationship between the Xe concentration and the self-oscillating light energy.

For example, in the case where the permissible value for the self-oscillating light energy is taken as E0, a relationship curve between the self-oscillating light energy and the Xe concentration may exceed E0 with an increase in the Xe concentration. At this time, the Xe concentration at the point where the relationship curve exceeds ED may be taken as Cmax. As a result of experiments performed using a slab amplifier, the inventors discovered that a Xe concentration that does not exceed a useful value for E0 is no greater than 1%.

In a more preferable case, the inventors confirmed that the Xe concentration at a permissible self-oscillating light energy E0=0(W), which is below a detection limit of an energy detector, is 0.72%.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

1. A laser apparatus comprising:
a master oscillator configured to output a pulse laser beam;
at least one amplifier disposed in an optical path of the pulse laser beam;
an energy detector that is disposed in the optical path on one of an input side and an output side of the amplifier and that is configured to detect energy of self-oscillating light from the amplifier;
a gain adjustment section configured to adjust a gain of the amplifier; and
a control unit configured to control the gain adjustment section based on a detection result from the energy detector when a pulse laser beam is not being inputted into the amplifier from the master oscillator.

2. The laser apparatus according to claim 1,
wherein the amplifier contains a CO₂ laser gas and is configured to discharge-pump the CO₂ laser gas.

3. The laser apparatus according to claim 2,
wherein the gain adjustment section is configured to adjust a composition of the CO₂ laser gas.

4. The laser apparatus according to claim 3,
wherein the gain adjustment section is configured to adjust a gas concentration of at least one of CO₂, N₂, and Xe within the laser gas.

5. The laser apparatus according to claim 4,
wherein the gain adjustment section is configured to adjust the concentration of Xe gas to no greater than 1%.

6. The laser apparatus according to claim 2,
wherein the gain adjustment section includes a power source configured to adjust a pumping intensity through discharge.

7. A laser apparatus comprising:
a master oscillator configured to output a pulse laser beam; and
at least one amplifier disposed in an optical path of the pulse laser beam,
the amplifier being a slab amplifier containing Xe gas as a CO₂ laser gas.

8. The laser apparatus according to claim 7,
wherein the Xe concentration in a laser gas in the slab amplifier is no greater than 1%.

9. An extreme ultraviolet light generation apparatus comprising the laser apparatus according to claim 1.

10. A laser apparatus comprising:
at least one amplifier configured to amplify a pulsed laser from a master oscillator;
an energy detector configured to detect energy of self-oscillating light from the amplifier; and
a control unit configured to adjust a gain of the amplifier based on a detection result from the energy detector when a pulse laser beam is not being inputted into the amplifier from the master oscillator.
